(19) United States
(12) Patent Application Publication
(10) Pub. No.: US 2006/0215589 A1
(43) Pub. Date: Sep. 28, 2006

(54) In vehicle video communication system

(76) Inventors: Yuriy Taborisskiy, West Bloomfield, MI (US); Zinoviy Kelman, Bloomfield Hills, MI (US); Oleg Gaidoukevitch, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 11/089,504

(22) Filed: Mar. 24, 2005

(51) Int. Cl. H04B 7/00

(52) U.S. Cl. 370/310

(57) ABSTRACT

A vehicle communication system includes a vehicle cluster having a CPU. The CPU includes a transceiver that is adapted to directly communicate with a remote terminal via a GSM protocol to send and receive video and audio data. A display monitor is coupled to the CPU and receives an output video data signal from the CPU. The display monitor generates a video image that is based on incoming video data transmitted from the remote terminal to the transceiver. A camera is coupled to the CPU and transmits an input video data signal. A speaker is coupled to the CPU and receives an output audio signal. A microphone is coupled to the CPU and transmits an input audio signal to the CPU. The CPU sends an outgoing audio and video signal to the remote terminal in response to receipt of the input audio and video signal.

### FIELD OF THE INVENTION

The present invention relates to remote video communication and more specifically to real-time video communication between a vehicle and another remote location.

### BACKGROUND OF THE INVENTION

Wireless communication has evolved substantially in recent years. Technology and availability have allowed consumers access to a wide range of mobile communication devices including cell phones, pagers and other devices. One place mobile communication occurs frequently is in a vehicle. Some vehicles include mobile telephones built into the architecture of the vehicle.

One wireless technology platform includes Global System for Mobile Communications (GSM). GSM is a non-proprietary communication system available in over 170 countries. GSM uses digital technology and time division multiple access transmission methods. Such a transmission method permits a very efficient data rate to information content ratio. The most recent GSM format being developed includes 3GSM. 3GSM is based on the GSM standard and includes an additional radio air interface better suited to high speed and multimedia data services. 3GSM will offer enhanced capacity, quality and data rates over standard GSM.

### SUMMARY OF THE INVENTION

A vehicle communication system includes a vehicle cluster having a CPU. The CPU includes a transceiver that is adapted to directly communicate with a remote terminal via a GSM protocol to send and receive video and audio data. A display monitor is coupled to the CPU and receives an output video data signal from the CPU. The display monitor generates a video image that is based on incoming video data transmitted from the remote terminal to the transceiver.

A camera is coupled to the CPU and transmits an input video data signal to the CPU. The CPU sends an outgoing video signal through a GSM module to the remote terminal in response to receipt of the input video data signal. A speaker is coupled to the CPU and receives an output audio signal from the CPU. The speaker generates an audio signal that is based on audio data transmitted from the remote terminal to the transceiver. A microphone is coupled to the CPU and transmits an input audio signal to the CPU. The CPU sends an outgoing audio signal to the remote terminal in response to receipt of the input audio signal.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a partial perspective view of an in-vehicle video communication system constructed in accordance with the teachings of the present invention;

FIG. 2 is a partial perspective view of an in-vehicle video communication system constructed in accordance with additional features of the present invention,

FIG. 3 is a partial perspective view of an in-vehicle video communication system constructed in accordance with additional features of the present invention; and

FIG. 4 is a schematic illustration of the in-vehicle video communication system illustrated in FIG. 1.

### DETAILED DESCRIPTION OF THE PREFERRED EMBODIMENTS

The following description of the preferred embodiment(s) is merely exemplary in nature and is in no way intended to limit the invention, its application, or uses.

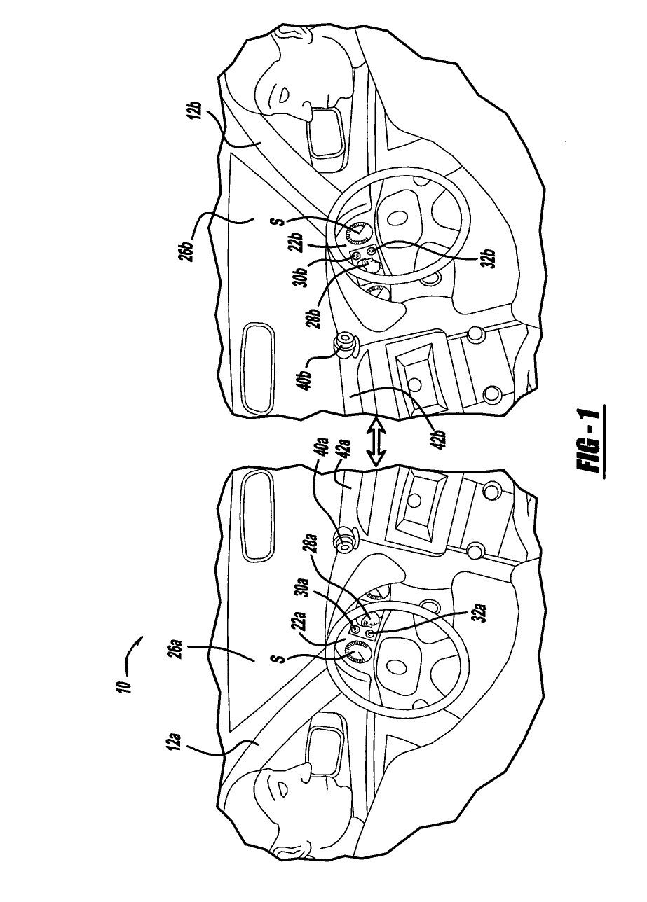

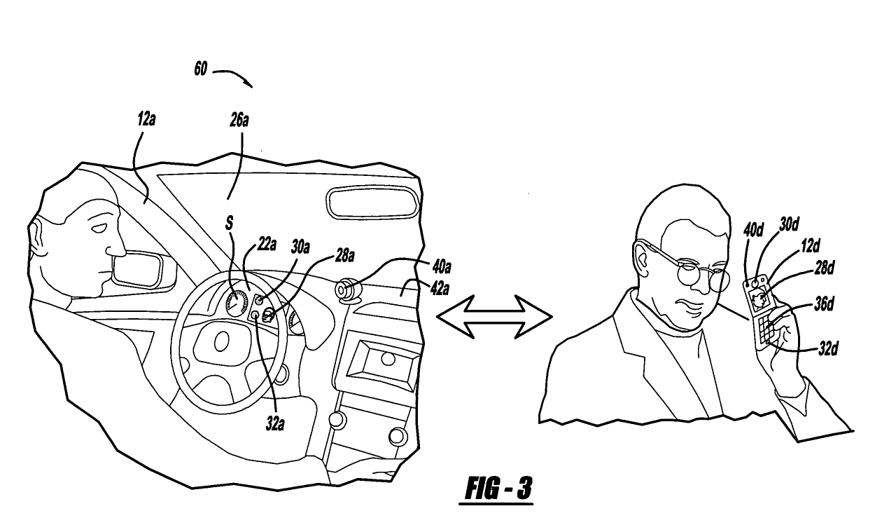

With initial reference to FIG. 1, an in-vehicle video communication system is shown and generally identified at reference numeral 10. In one example, the in-vehicle video communication system 10 provides video communication (or video conferencing) including audio and video communication between a first vehicle 12a and a second vehicle 12b. As illustrated in FIG. 1, the first and second vehicles 12a and 12b may each incorporate an instrument cluster 22a and 22b in a vehicle cabin 26a and 26b, respectively. Each instrument cluster 22a and 22b may include a video display 28a and 28b, a speaker 30a and 30b, a microphone 32a and 32b, a central processing unit (CPU) 36a and 36b (FIG. 3) and a wireless communication terminal such as transceiver or integrated GSM module 38a and 38b (FIG. 3). The GSM modules 38a and 38b are operable to communicate any GSM format such as, but not limited to, 3GSM. Each instrument cluster 22a and 22b can include one or more vehicle gages, such as a speedometer S, that can be operated or controlled by the CPU 36a and 36b to display a vehicle parameter such as vehicle speed.

While the displays 28a and 28b are illustrated as integral to each instrument cluster 22a and 22b, respectively, it is appreciated that each of the displays 28a and 28b may alternatively be arranged as part of a centralized console on a vehicle dash 42a and 42b, or elsewhere in each vehicle 12a and 12b. Furthermore, the displays 28a and 28b may share responsibility with other information devices such as, but not limited to, vehicle navigation systems, DVD players, display devices operable to reflect a video image on a windshield, or other video devices.

A camera 40a and 40b may be provided on the vehicle dash 42a and 42b. It is appreciated that the speaker 30a and 30b, microphone 32a and 32b and/or camera 40a and 40b may be arranged elsewhere in the vehicle cabin 26a and 26b. As will be described in greater detail, the in-vehicle video communication system 10 provided in the instrument clusters 22a and 22b with integrated GSM modules 38a and 38b are operable to communicate video and audio data communication between the first and second vehicles 12a and 12b.

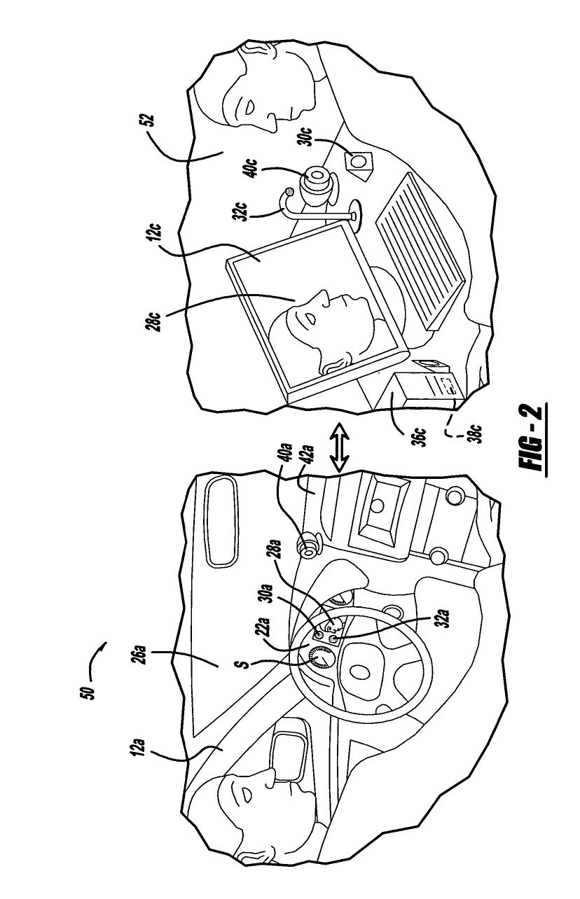

Turning now to FIG. 2, an in-vehicle video communication system 50 according to additional features is shown. The in-vehicle video communication system 50 is adapted to provide video communication between a vehicle such as the first vehicle 12a and a stationary location 52 such as a home or office. In one example, the stationary location 52 may include a computer 12c having a display 28c and a CPU 36c. The computer 12c may incorporate an integrated GSM module 38c. Furthermore, the computer 12c may also comprise a speaker 30c, a microphone 32c and a camera 40c. While illustrated as standalone components, the speaker 30c, microphone 32c and/or camera 40c may define integral components of the CPU 36c and/or the display 28c.

With reference now to FIG. 3, an in-vehicle video communication system 60 according to additional features is shown. The in-vehicle video communication system 60 is adapted to provide video communication between a vehicle such as the first vehicle 12a and a mobile hand held device 12d such as a cellular telephone. It is appreciated that the mobile hand held device 12d may alternatively comprise other handheld portable devices such as a PDA or laptop computer for example. The mobile hand held device 12d may comprise a display 28d, a speaker 30d, a microphone 32d, a CPU 36d, and a camera 40d.

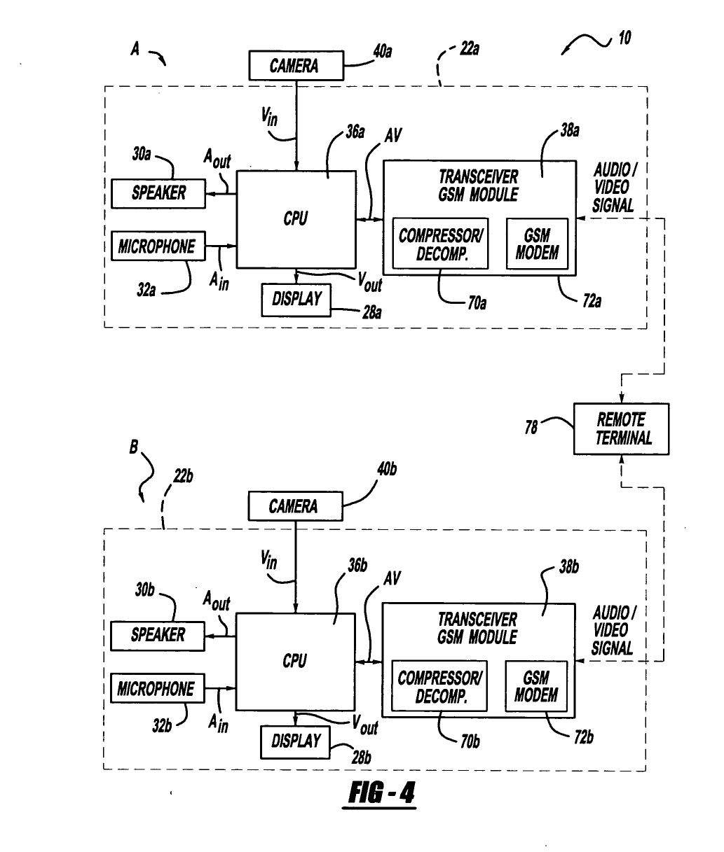

With continued reference to FIGS. 1-3 and further reference to FIG. 4, the in-vehicle video communication system 10 will be described in greater detail. The following discussion will be directed to the in-vehicle video communication system 10 as illustrated in FIG. 1 including the first vehicle 12a and the second vehicle 12b. For simplicity, reference A is used to identify a first location (such as vehicle 12a). Likewise, reference B is used to identify a second location (such as vehicle 12b). It is appreciated however, that reference B may also refer to the components incorporated in the computer 12c (FIG. 2) at the stationary location 52, and the components associated with the portable communication device 12d (FIG. 3).

The instrument cluster 22a generally includes the video display 28a, the speaker 30a, the microphone 32a, the CPU 36a and the transceiver 38a. The camera 40a may be arranged away from the cluster 22a and is operable to communicate with the CPU 36a. Again, the camera 40a may be located elsewhere in the vehicle 12a, such as a location integral with the cluster 22a. The transceiver 38a may comprise a GSM module having a compressor/decompressor 70a and a GSM modem 72a. The transceiver 38a is adapted to send and receive video and/or audio data between a remote terminal 78 utilizing a GSM protocol. In one example, the data may be transferred using Joint Photographic Experts Group (JPEG) 2000 standard technology. In short, JPEG 2000 is an image coding system that uses state of the art compression techniques based on wavelet technology. The JPEG coding system may be used for still pictures. MJPEG or Motion JPEG is an image coding system that may be used for video data coding.

In general, the camera 40a may be adapted to communicate an input video signal Vᵢₙ to the compressor/decompressor 70a where the input video signal Vᵢₙ is compressed. The input video signal Vᵢₙ is then communicated to the GSM modem 72a. Similarly, the microphone 32a may be adapted to communicate an input audio signal Aᵢₙ to the compressor/decompressor 70a where the input audio signal Aᵢₙ is compressed. The input audio signal Aᵢₙ is then communicated to the GSM modem 72a. The GSM modem 72a may send the video and/or the audio signals (AV) to the remote terminal 78 utilizing GSM protocol. The video and/or the audio signal then is communicated from the remote terminal 78 to the transceiver 38b at the second location B.

The second location B receives the video and/or the audio signals by the GSM modem 72b. The GSM modem 72b then communicates the video and/or the audio signals to the compressor/decompressor 70b where they are decompressed. The decompressed video signal may then be communicated as an output video signal Vₒᵤₜ to the video display 28b. Likewise, the decompressed audio signal may be communicated as an output audio signal Aₒᵤₜ to the speaker 30b. It is appreciated that video and audio communication from the second location B to the first location A may be accomplished in a similar manner.

It is contemplated that initiation of an audio/video transmission between the first and second locations A and B may be accomplished by utilizing conventional buttons and/or switches provided in the vehicle cabin 26a and 26b, the computer 12c and/or the portable communication device 12d. In one example, a driver may utilize a menu driven interface provided on the display 28a and 28b. Other methods may also be employed such as interface locations provided on a vehicle dash 42a and 42b, steering wheel, or elsewhere in the vehicle 12a and 12b. Voice activated commands may also be used as criteria for initiating such communication.

While the invention has been described in the specification and illustrated in the drawings with reference to various embodiments, it will be understood by those skilled in the art that various changes may be made and equivalents may be substituted for elements thereof without departing from the scope of the invention as defined in the claims. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as appropriate, unless described otherwise above. Moreover, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. A vehicle communication system comprising:
a vehicle instrument cluster having a CPU, said CPU including a transceiver that is adapted to directly communicate with a remote terminal via a GSM protocol and to send and receive video and audio data;
a display monitor coupled to said CPU and receiving an output video data signal therefrom and responsively generating a video image that is based on incoming video data transmitted from said remote terminal to said transceiver;
a camera coupled to said CPU and transmitting an input video data signal thereto, said CPU sending an outgoing video signal through said transceiver to said remote terminal in response to receipt of said input video data signal;
a speaker coupled to said CPU and receiving an output audio signal therefrom and responsively generating an incoming audio signal that is based on audio data transmitted from said remote terminal to said transceiver; and
a microphone coupled to said CPU and transmitting an input audio signal thereto, said CPU sending an outgoing audio signal to said remote terminal in response to receipt of said input audio signal.

2. The vehicle communication system of claim 1 wherein said transceiver comprises a GSM module.

3. The vehicle communication system of claim 2 wherein said GSM module comprises a modem.

4. The vehicle communication system of claim 3 wherein said GSM module comprises a signal compressor and decompressor.

5. The vehicle communication system of claim 3 wherein said signal compressor and decompressor is adapted to compressor and decompress a video signal

6. The vehicle communication system of claim 5 wherein said signal compressor and decompressor is adapted to compressor and decompress an audio signal.

7. The vehicle communication system of claim 6 wherein said signal compressor and decompressor is operable to compress an outgoing audio and video signal and decompress an incoming audio and video signal.

8. A vehicle communication system comprising:
a first vehicle; and
a remote location;
wherein each of said first vehicle and said remote location comprise:
a CPU, said CPU including a transceiver that is adapted to directly communicate with a remote terminal via a GSM protocol and to send and receive video and audio data;
a display monitor coupled to said CPU and receiving an output video data signal therefrom and responsively generating a video image that is based on incoming video data transmitted from said remote terminal to said transceiver;
a camera coupled to said CPU and transmitting an input video data signal thereto, said CPU sending an outgoing video signal through a GSM module to said remote terminal in response to receipt of said input video data signal;
a speaker coupled to said CPU and receiving an output audio signal therefrom and responsively generating an incoming audio signal that is based on audio data transmitted from said remote terminal to said transceiver; and
a microphone coupled to said CPU and transmitting an input audio signal thereto, said CPU sending an outgoing audio signal to said remote terminal in response to receipt of said input audio signal.

9. The vehicle communication system of claim 8 wherein said remote location is selected from the group consisting of: a second vehicle, a home, an office, a PDA and a cellular telephone.
